(19) United States
(12) Patent Application Publication
(10) Pub. No.: US 2001/0035874 A1
(43) Pub. Date: Nov. 1, 2001

(54) Method for prolonging CRT screen life by reduced phosphor burning

(75) Inventors: William Eric Hamilton, Clovis, CA (US); Samuel Nikolay Grigorian, Fresno, CA (US)

Correspondence Address: MARK D MILLER, KIMBLE, MACMICHAEL & UPTON, 5260 NORTH PALM AVENUE, SUITE 221, FRESNO, CA, 93704, US

(73) Assignee: Pelco

(21) Appl. No.: 09/844,046

(22) Filed: Apr. 26, 2001

Related U.S. Application Data
(60) Provisional application No. 60/200,073, filed on Apr. 27, 2000.

(51) Int. Cl. G09G 5/00

(52) U.S. Cl. 345/682; 345/867; 348/173

(57) ABSTRACT

Disclosed is a method for reducing the burning of the phosphor of cathode ray tube (CRT) monitor screens used in television systems where necessary textual information is constantly displayed over a video image on the CRT screen. The method involves periodically changing the location of the textual information overlaid onto the video image without altering the information itself so that the information is continuously available, but does not remain in the same place for a prolonged time period which might otherwise burn into the phosphor of the CRT screen. The textual information may be moved as frequently as once per hour to as seldom as once every week or more; and may be move as little as one pixel to as much as several character positions. It is preferred that timing and location of movement of the textual information not be annoying to the user, and that the textual information be positioned discretely on the CRT screen in order to avoid blockage of the underlying video image as much as possible.

### BACKGROUND OF THE INVENTION

1. Field of the Invention

This invention relates to a method and system for prolonging the life of a cathode. ray tube (CRT) screen, and more particularly to a method for reducing the phosphor burn of a CRT screen of a monitor when used with constantly displayed textual information over a video image.

2. Description of the Prior Art

In many industries including the closed-circuit television (CCTV) industry, it is typical for one or more cameras to provide a video image to a CRT monitor. It is often important for textual information to also be displayed with the video image on the screen of the CRT monitor. This textual information typically includes the date, time, location and potentially other relevant information regarding the video image transmitted by the camera. The video image itself is subject to changes in accordance with changes in the scene observed by the camera. However, much of the textual information on the CRT screen (such as the position, location, identification and/or number of the camera) remains constant for very long periods of time (weeks, months or years), often for the life of the system. Even the time and date, which are at least subject to some change, will repeat the same information over and over.

In current CCTV systems, the position of the textual information remains constant on the monitor screen. In addition, because the information is textual in nature, in order to be readily seen, the textual information tends to have a sharp contrast to the underlying video image on the screen. When such maximum levels of brightness are maintained solidly “on” in the same position for long periods of time, the phosphor of the CRT screen in this area is subject to damage (i.e. “burning in”). As a result, images displayed in the burned region may be fuzzy, blurry or even blank, eventually rendering that region of the screen unusable for any display.

CRT screen savers are well known in the art. However, such screen savers automatically replace the information on the entire screen with a non-static (i.e. moving) video display, after a specific elapsed time. Such screen savers are inappropriate in many industries including the CCTV industry since the CRT monitors must constantly provide a true, accurate and undistorted video image as well as readable corresponding textual information. This important video and textual information cannot be periodically replaced with a screen saver.

U.S. Pat. No. 4,677,430 describes a method for imperceptibly moving a video display within the CRT in both vertical and horizontal directions in order to prevent burn-in of the CRT phosphor. The method of this patent involves shifting the entire screen display by incrementally increasing and/or decreasing a delay in the synchronization signal for a maximum horizontal displacement of ⅔ of the width of a character, and a maximum vertical displacement of the height of one character. However, these are small maximum displacements, the entire image is affected, and it requires complex tampering with the synchronization signal.

It is therefore desirable to provide a simple method for avoiding CRT monitor phosphor burning in a television monitor system where an underlying video image is displayed along with largely unchanging textual information by periodically changing the location of the textual information.

### SUMMARY OF THE INVENTION

The present invention provides a method for prolonging the life of a CRT screen by reducing the potential for phosphor burn from the high-contrast textual information displayed on the CRT screen by periodically moving the textual information displayed on the screen without changing the underlying video image. This is accomplished by occasionally changing the location of the textual information on the screen so that it does not remain in the same place for prolonged periods of time. The timing for the movement of the textual information should not be so frequent as to be annoying to a user, but should be often enough to avoid burning the CRT screen phosphor. Similarly, the amount of movement should also be sufficient to accomplish this purpose without undue annoyance to the user. In all cases, it is important that the textual information be relegated to discrete locations on the CRT screen in order that it not interrupt the underlying video image any more than necessary. Typically, the textual information will be displayed at the bottom of the CRT screen, or near the corners of the CRT screen, and moved to different positions within these general locations.

It is therefore a primary object of the present invention to provide a method for prolonging the life of CRT screens used in monitors which display video and textual information by periodically changing the position of the textual information displayed on the screen in order to reduce phosphor burn.

It is also an important object of the present invention to provide a method for reducing phosphor burn on the monitor screen of a CRT used to display video and textual information by periodically changing the position of textual information displayed on the screen.

It is a further object of the present invention to provide a method for prolonging the life of a CRT monitor screen used in the CCTV industry by moving the position of textual information displayed on the screen without changing the underlying video image from the CCTV surveillance camera.

Additional objects of the invention will be apparent from the detailed descriptions and the claims herein.

### BRIEF DESCRIPTION OF THE DRAWINGS

FIG. 1 is a diagrammatic view of a CRT screen showing an example set of overall character positions, and a smaller window of a subset of character positions.

FIG. 2 is a diagrammatic view of a CRT screen showing an example set of overall character positions, and an example starting position of a window of subset character positions.

FIG. 3 is a diagrammatic view of a CRT screen showing an example set of overall character positions, and an example second position of a window of subset character positions.

FIG. 4 is a diagrammatic view of a CRT screen showing an example set of overall character positions, and an example third position of a window of subset character positions.

FIG. 5 is a diagrammatic view of a CRT screen showing an example set of overall character positions, and an example fourth position of a window of subset character positions.

### DETAILED DESCRIPTION OF THE PREFERRED EMBODIMENT

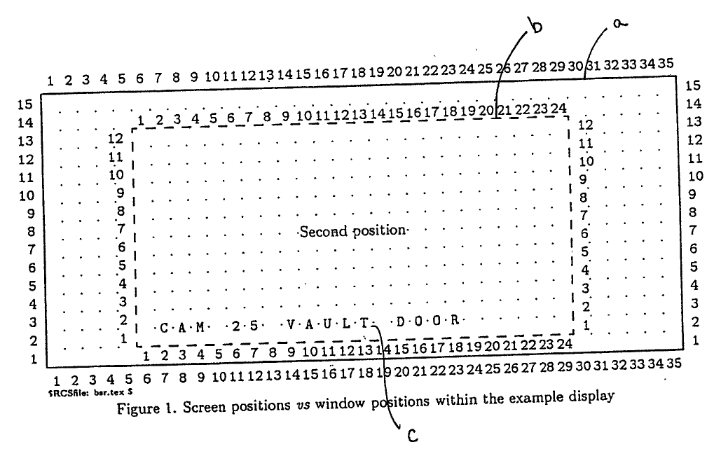

Referring to the drawings wherein like reference characters designate like or corresponding parts throughout the several views, and referring particularly to FIG. 1 it is seen that an example CRT display a is shown having character positions available for textual information in fifteen (15) rows, each row having a maximum of thirty-five (35) character positions. The 15×35 character spacing is provided by a typical character generator chip; however alternative character generator chips may be used which provide greater or fewer rows and/or greater or fewer characters per row. In the example of FIG. 1, a window b for the character display is provided having twelve (12) rows, each row having a maximum of twenty-four (24) character positions. Window b may be larger or smaller, depending upon the application. Within the smaller window b, textual information is provided. In this example, the words “CAM 25 VAULT DOOR” referring to “camera 25” showing the real time condition of the “vault door” are provided at the bottom of the window b; however, additional textual information could be included anywhere in this window. In accordance with the present invention, display window b containing the textual information is moved on a periodic basis in order to prevent the textual information from burning into the phosphor of the CRT screen.

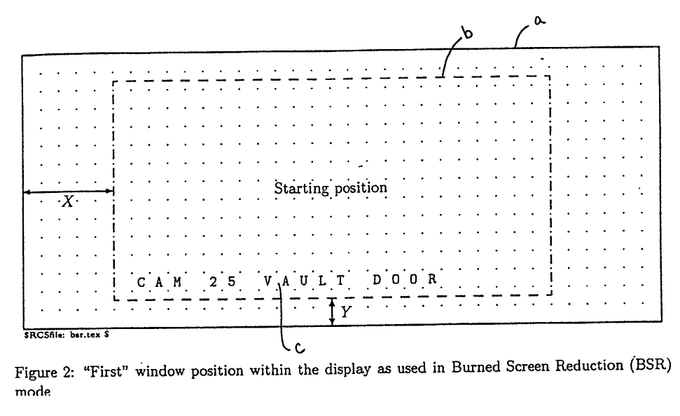

FIG. 2 shows an example starting position for display window b (e.g. at power up). The bottom of window b is X units from left edge of CRT screen a, and Y units from the bottom of CRT screen a. Units X and Y may be of any appropriate size, ranging from one pixel up to several characters. In this example, units X are one full character width in the horizontal direction, and units Y are one-half a character height in the vertical direction.

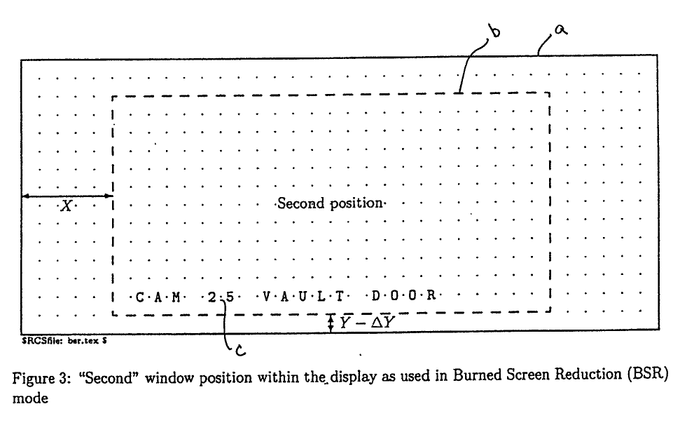

FIG. 3 shows a second position for display window b that has been moved. In this example, window b has been moved down by the amount ΔY. The distance ΔY may be positive or negative (resulting in downward or upward movement on the screen). In this example, the distance ΔY is one-half of a character height. This movement may occur at any convenient time, at a regular or irregular interval, as described more fully below.

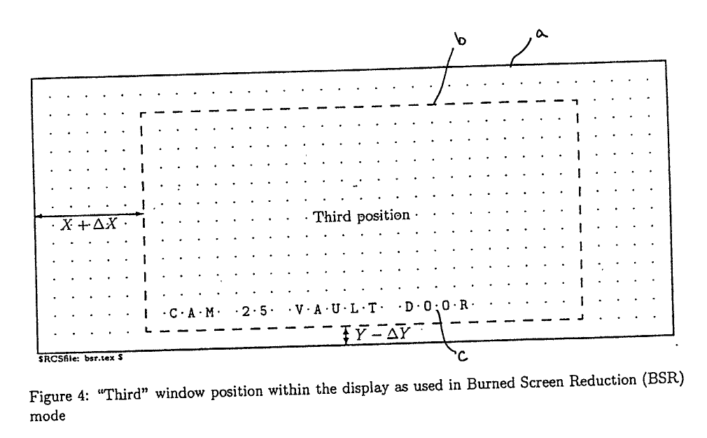

FIG. 4 shows a third position for display window b that has been moved. In this example, window b has been moved down by the amount ΔY, and to the right by the amount of ΔX. The distance ΔX may be positive or negative (resulting in right or left movement on the screen). In this example, the distance ΔX is one full character width.

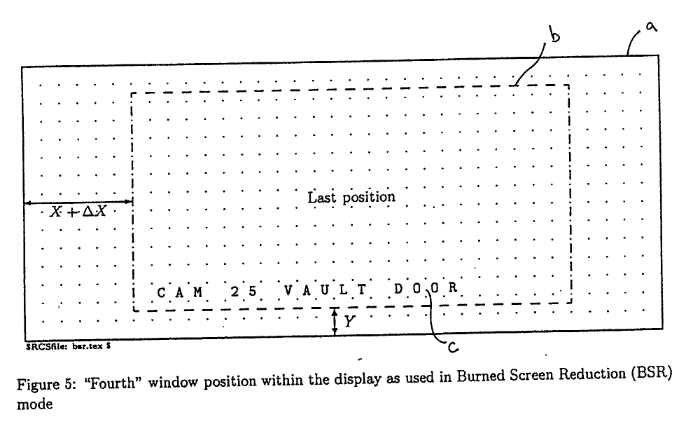

FIG. 5 shows a fourth position for display window b that has been moved. In this example, window b has been moved to the right by the amount of ΔX.

It is to be understood that the positions shown in FIGS. 1-5 are illustrative and by way of example only, and do not limit the scope of the claims herein. The movements are not limited to only four positions as there may be a fewer or greater number of positions used in the method of the present invention. Numerous other alternative incremental movement amounts may be made ranging from one pixel up to several characters of text, and numerous other alternative movement times may be used ranging from once per second up to once per month.

The movement of the textual information in the present method is accomplished by providing instructions to the character generator chip or circuit for the CRT display. Information is occasionally provided to the character generator chip to change the location of the textual information. This may be accomplished in a variety of ways. For example, the entire character display may be moved one character position to the right by inserting an additional “blank” or space character in each line. Similarly, the entire character display may be moved down one line by inserting a blank line at the beginning of the text. However, if these methods are implemented, the user should confirm that insertion of such blank lines or blank characters will not affect the underlying video display. Alternatively, the character generator chip may be provided with instructions to move the textual data on the display by more or less than one full character position. Of course, an incremental movement of too many characters runs the risk of sending the data off the CRT screen.

Typical character generator chips allow textual information to be displayed in one of several formats including providing a blanked-out background box or rectangle against which the character is displayed (e.g. closed caption), providing a character with a black or white outline around it (depending on whether the character itself is white or black), or providing just the character itself (such that the underlying video may be seen through the gaps in the character). The last display option of providing just the character itself is preferred in order to cause the least interruption to the underlying video.

The amount of movement of display window b will depend upon several factors, but preferably when the movement occurs, display window b will only be moved by the smallest available increment. A typical incremental movement may be 10 pixels.

It is important that as much of the underlying video image be available for viewing on the monitor and that any interruption or blockage of the video by the textual information be minimized. Accordingly, it is preferred that the textual information be relegated to appropriately discrete areas of the display, such as at or near the bottom, or at or near the corners of the CRT screen. It is not anticipated that the movement of the textual information according to the present invention would place such information directly into the center of the display where it could block critical parts of the underlying video image.

It is to be appreciated that the timing for the movement of display window b may be established according to any regular or irregular schedule, and that the movement may occur as frequently as a few times per minute, to as seldom as once a week or even longer. The movement may take place regularly (e.g. once every ten minutes, once every 24 hours, once every Friday), or irregularly (e.g. randomly once every hour).

It is preferred that the movement of the textual information be accomplished without undue annoyance to the user. Accordingly, the textual information should be allowed to remain in any given location long enough for it to be easily read by the user, and that such textual information should not be unnecessarily jumping around on the screen. When movement of the textual information occurs, it is likely to take place suddenly and obviously, and not necessarily imperceptibly (although this is possible if very small increments of movement are used). In order to avoid annoyance, it is suggested that the movements occur no less frequently than once per hour, although greater or lesser frequencies are included within the scope of the invention. And, while the textual information may abruptly “jump” according to the present invention, this may or may not be perceptible by the user, depending upon the amount of movement (whether 10 pixels or several characters). A typical scenario might have the textual information jump back and forth between the bottom corners of the CRT display, at different locations within these general areas each time. In so doing, the “live” underlying video part of the display is not affected.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A method of preparing a display screen of a cathode ray tube (CRT) type monitor and in a closed-circuit television (CCTV) system from experiencing phosphor burn as a result of persistent display of textual information overlaid onto a closed circuit video image, the method comprising the steps of moving a position of the textual information relative to the image as displayed on the monitor by a relatively small predefined amount on a periodic basis.

2. The method of claim 1 wherein the predefined amount is the smallest addressable screen unit on the display.

3. The method of claim 1 wherein the predefined amount is one pixel.

4. The method of claim 1 wherein the predefined amount is a relatively small predefined random number of pixels.

5. The method of claim 1 wherein the predefined amount is one full character step.

6. The method of claim 1 wherein the periodic basis is at least once per hour.

7. The method of claim 2 wherein the periodic basis is at least once per day.

8. The method of claim 1 wherein the textual information is displayed near the bottom of the CRT screen.

9. The method of claim 7 wherein the textual information is displayed near one of the two bottom comers of the CRT screen.

10. A method of reducing phosphor burn on the display screen of a cathode ray tube (CRT) type monitor in a television system where a video image and textual information is simultaneously displayed on the CRT screen resulting from persistent display of textual information overlaid onto said video image, the method comprising the steps of moving a position of the textual information relative to the video image as displayed on the monitor by a relatively small predefined amount on an occasional basis.

11. The method of claim 10 wherein the predefined amount is the smallest addressable screen unit on the display.

12. The method of claim 10 wherein the predefined amount is one pixel.

13. The method of claim 10 wherein the predefined amount is a relatively small predefined random number of pixels.

14. The method of claim 10 wherein the predefined amount is one full character step.

15. The method of claim 10 wherein the periodic basis is at least once per hour.

16. The method of claim 11 wherein the periodic basis is at least once per day.

17. The method of claim 10 wherein the textual information is displayed near the bottom of the CRT screen.

18. The method of claim 16 wherein the textual information is displayed near one of the two bottom comers of the CRT screen.
